(19) United States
(12) Patent Application Publication
(10) Pub. No.: US 2026/0236561 A1
(43) Pub. Date: Aug. 13, 2026

(54) PROVIDING DATA FROM SENSOR NODE BASED ON DATA SUFFICIENCY LOGIC

(71) Applicant: STMicroelectronics International N.V., Geneva (CH)

(72) Inventors: Swapnil Sayan SAHA, Mountain View, CA (US); Mahesh CHOWDHARY, San Jose, CA (US)

(73) Assignee: STMicroelectronics International N.V., Geneva (CH)

(21) Appl. No.: 19/048,667

(22) Filed: Feb. 7, 2025

(51) Int. Cl. G06F 18/2413; G06F 18/2135

(52) U.S. Cl. CPC G06F 18/2413; G06F 18/2135

(57) ABSTRACT

Techniques for providing data from a sensor node based on data sufficiency logic are described. A data window is obtained via a sensor node. A plurality of features are extracted from the data window. The extracted features are provided to an approximation classifier that is configured to approximate performance of a sensor node classifier implemented using the sensor node. An approximation classification representative of a classification of the data window that would be made by a sensor node classifier is obtained from the approximation classifier. The extracted features are provided to a reference classifier. A reference classification is obtained from the reference classifier. Using data sufficiency logic and based on the approximate classification and the reference classification, a determination is made whether to provide the data window to a computing device.

### TECHNICAL FIELD

The present disclosure relates to providing data from a sensor node to a cloud computing device based on data sufficiency logic.

### Background

Billions of cloud-connected devices collectively transmit zetabytes of data to the cloud. For example, smartphones, smart watches, IoT devices, etc. may transmit sensor data, usage data, etc. to the cloud. In many instances, this data cannot be used productively and transmitting the data to the cloud needlessly consumes network bandwidth and other computing resources.

### BRIEF SUMMARY

Techniques for providing data from a sensor node based on data sufficiency logic are described. A data window is obtained via a sensor node. A plurality of features are extracted from the data window. The extracted features are provided to an approximation classifier that is configured to approximate performance of a sensor node classifier implemented using the sensor node. An approximation classification representative of a classification of the data window that would be made by a sensor node classifier is obtained from the approximation classifier. The extracted features are provided to a reference classifier. A reference classification is obtained from the reference classifier. A determination whether to provide the data window to a cloud computing device is made based on the reference classification and the approximate classification.

In some embodiments, the determination whether to provide the data window to the computing device is made based on a sufficiency of data having a problem-specific data class of the data window accessible to the computing device.

In some embodiments, the determination whether to provide the data window to the computing device is made based on a sufficiency of data having an action primitive of the data window accessible to the computing device.

In some embodiments, the determination whether to provide the data window to the computing device is made based on a relevancy of the data window to a classification task.

In some embodiments, the determination whether to provide the data window to the computing device is made based on whether the data window is anomalous or an outlier.

In some embodiments, the determination whether to provide the data window to the computing device is made based on whether the data window is redundant to data accessible to the computing device.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings:

FIG. 1 is a context diagram of a non-limiting embodiment of systems that provide functionality to upload data from a sensor node based on data sufficiency logic in some embodiments.

FIG. 2 is a logical flow diagram illustrating a process for determining whether to upload data from a sensor node based on data sufficiency logic in some embodiments.

FIG. 3 is a logical flow diagram illustrating a process implementing data sufficiency logic in some embodiments.

FIG. 4 is a logical flow diagram illustrating a process for generating artifacts usable to determine whether to upload data from a sensor node in some embodiments.

FIG. 5 is a system diagram illustrating one implementation of computing systems for implementing embodiments described herein.

### DETAILED DESCRIPTION

Cloud-connected devices (i.e., “sensor nodes”) such as smart watches often generate large amounts of data that is routinely sent to the cloud for various purposes, such as for improving performance of the cloud-connected device, analytics, etc. But according to conventional techniques, sensor node data is often sent to the cloud without determining whether the sensor node data can be used for any relevant purpose. For example, sensor node data is often automatically streamed to the cloud as soon as it becomes available from the sensor node. Accordingly, the data sent to the cloud may be cumulative, redundant, or otherwise cannot be used to improve performance of the cloud-connected device. Therefore, according to conventional techniques, potentially vast network bandwidth and other computing resources may be expended to obtain sensor node data that provides little or no benefit.

In some cases, information is sent to the cloud to enable artificial intelligence algorithms to be trained in the cloud and deployed to a cloud-connected device. For example, a smart watch may upload sensor data to the cloud through a gateway device such as a smartphone or laptop. The sensor data may then be used to train classifiers for use with the smart watch, such as a classifier that determines what activity a user is performing based on sensor data. But much of the data transmitted from cloud-connected devices to the cloud is redundant or cannot be used to improve performance of the cloud-connected device. For example, when a smart watch is left on a table for hours, it may not be necessary to continuously transmit the same sensor data to the cloud. Sending this data to the cloud consumes processing and network resources but typically cannot be used improve performance of the device.

In response to the disadvantages of conventional techniques for sending data to the cloud from cloud-connected devices, the inventors have conceived of techniques for uploading data from a sensor node based on data sufficiency logic. As discussed herein, a sensor node often implements a classifier to classify data measured using one or more sensors of the sensor node. Processing resources at sensor nodes are typically limited. Thus, the sensor node classifier may have limited performance compared to other classifiers.

The inventors have recognized that a relevance of data for improving the sensor node classifier can be determined using a gateway device. The gateway device simulates a classification of the data by the sensor node classifier, such as by executing an approximation classifier with similar performance to the sensor node classifier. The gateway device also produces a reference classification using a reference classifier. In various embodiments, the reference classifier implement an architecture having a larger number of parameters, algorithms requiring more processing resources than the sensor node classifier, etc. The reference classifier typically has improved performance on the relevant classification task as compared to the sensor node classifier or the approximation classifier.

Based on the classifications, data sufficiency logic is used to determine whether to provide the data to a cloud computing device. In various embodiments, the data sufficiency logic includes comparing a classification of the approximation classifier to a classification of the reference classifier. In some embodiments where the classifications do not agree, it indicates that the sensor node classifier classifies the data incorrectly and the data is to be sent to a cloud computing device to be used to improve performance of the sensor node classifier. In some embodiments where the classifications agree, it indicates that the sensor node classifier classifies the data correctly and the data is not to be sent to the cloud.

Additionally, in various embodiments, techniques for determining whether to provide data to a cloud computing device are lightweight and capable of being executed at a gateway device at relatively high frequencies such as 6.6kHz, such that a determination whether to send a data window to the cloud computing device can be made before a next sample or data window is received from the sensor node.

By performing in some or all of the ways described above, the data from a sensor node is provided to a computing device based on data sufficiency logic. Techniques described herein improve the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. In one non-limiting example, by preventing transmission of data from a sensor node that is not useful for improving performance of the sensor node, computing resources that would otherwise be dedicated to these transmissions is conserved. In another non-limiting example, by identifying sensor node data that can be used to improve performance of the sensor node, performance of the sensor node can be improved. Additionally, training a sensor node classifier implemented using the sensor node is more efficient because irrelevant data is not used.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, a human mind cannot determine whether to provide data samples as they are obtained from a sensor node because data samples are often obtained hundreds or thousands of times per second.

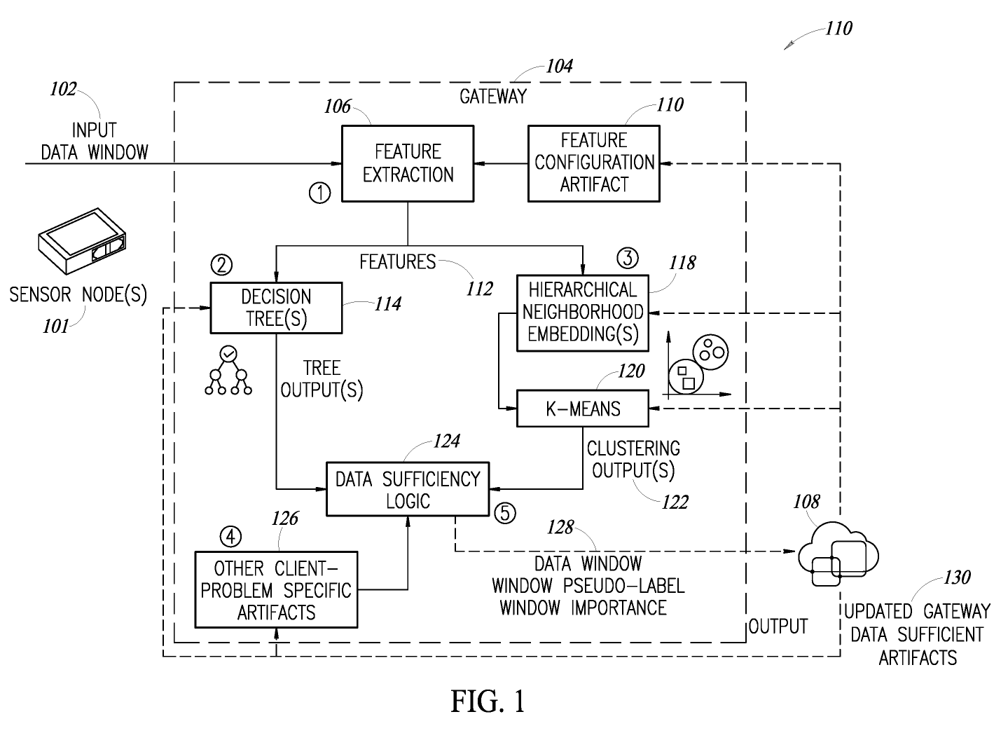

FIG. 1 is a context diagram of a system 100 that provides functionality to upload data from a sensor node based on data sufficiency logic in some embodiments.

System 100 includes sensor node 101, gateway device 104, and cloud computing device 108. Sensor node 101 is a device such as a smart watch, internet of things (i.e., “IoT”) device, smart sensor, etc. that is configured to obtain data such as data window 102 and provide the data to another device such as gateway device 104. In various embodiments, sensor node 101 implements a sensor node classifier to classify data measured using sensor node 101. In various non-limiting examples, sensor node 101 is configured to monitor a drilling machine, fan coil, gestures, human activity, track assets, etc.

Gateway device 104 is a computing device such as a smartphone, laptop computer, desktop computer, router, single board computer such as a Raspberry Pi, special purpose computing device, etc. Gateway device 104 is configured to receive data such as data window 102 from sensor node 101 and determine whether to transmit the data, a derivative thereof, or both, to cloud computing device 108. In one non-limiting example where gateway device 104 determines that data is to be provided to cloud computing device 108, gateway device 104 provides data including data window 102, a window pseudo-label, and a window importance to cloud computing device 108.

Cloud computing device 108 is a bare metal server, virtual machine, application container, cloud instance, other computing device, etc. or any combination thereof. In some embodiments, cloud computing device 108 is configured to use data received from gateway device 104 to train an updated sensor node classifier to be deployed to sensor node 101. In various embodiments, cloud computing device is configured to use data received from gateway device 104 to enable real-time monitoring, aggregate the data with data from other devices, diagnostics, etc. In some embodiments, cloud computing device 108 is configured to provide remote access to sensor node 101.

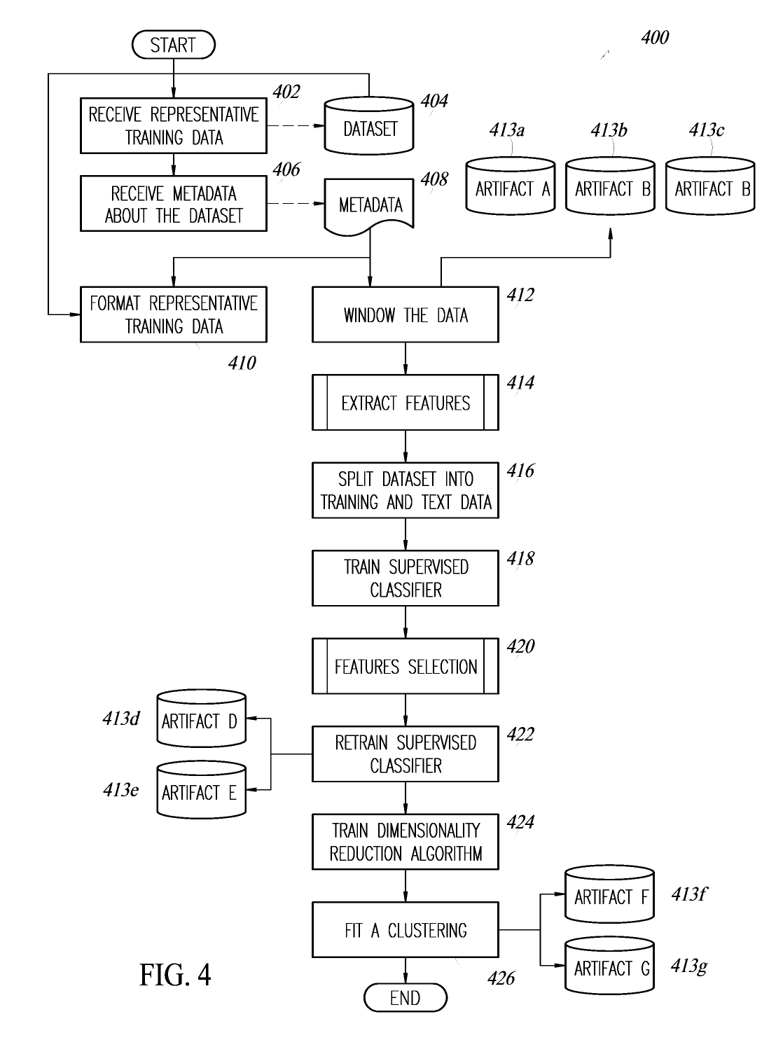

In various embodiments, cloud computing device 108 stores data regarding AI/ML model evolution, training or testing data and related artifacts. Example of how the data is used is shown in discussion above. In some embodiments, cloud computing device 108 retrains a sensor node classifier. In some embodiments, cloud computing device 108 generates artifacts used by the gateway device to determine whether to provide data windows to cloud computing device 108. Non-limiting examples of processes for generating artifacts, such as for retraining the sensor node classifier are discussed at least with respect to FIG. 4.

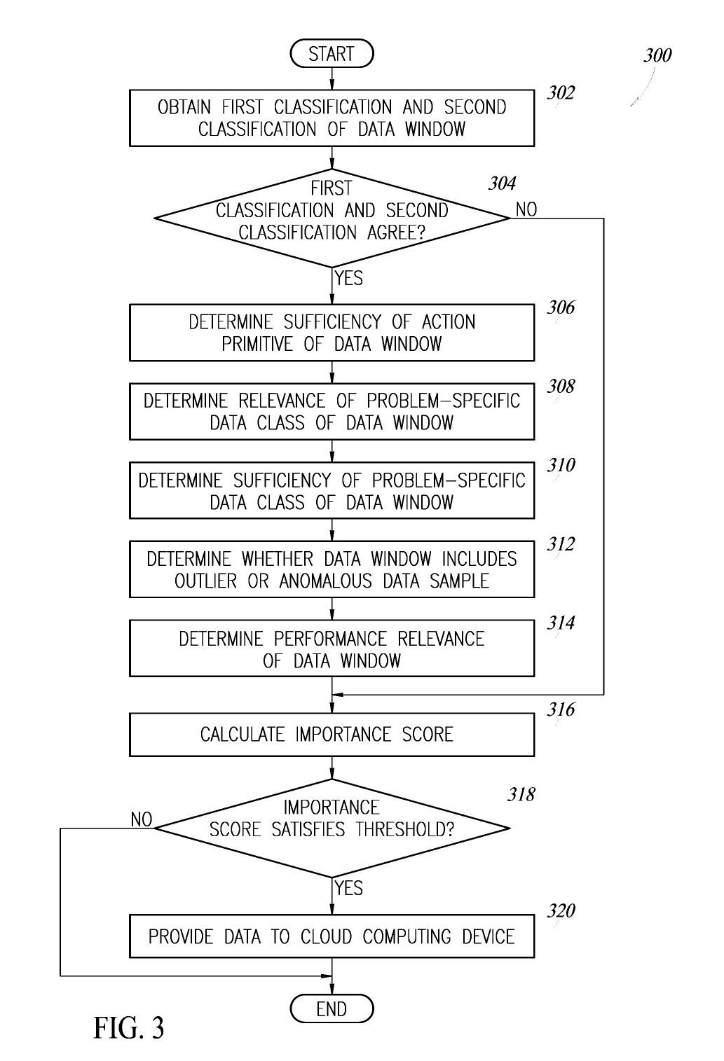

Gateway device 104 includes feature extraction 106, approximation classifier 114 (labeled “Decision Tree(s)”), reference classifier 120 (labeled “K-means”), and data sufficiency logic 124. As discussed herein, gateway device 104 uses data sufficiency logic 124 to determine whether to provide data window 102 to cloud computing device 108 based on output of approximation classifier 114 and reference classifier 120. Data sufficiency logic 124 is described in further detail at least with respect to FIG. 3.

In various embodiments, capabilities of gateway device 104 are implemented through hardware, software, or any combination thereof. In one non-limiting example, decision tree 114 is implemented using a field programmable gate array or a special-purpose computer. In another non-limiting example, feature extraction 106 is implemented using a processor such as a general-purpose processor.

Gateway device 104 receives data window 102 and extracts one or more features of data window 102 using feature extraction 106. In various embodiments, feature extraction 106 is performed based on feature configuration artifact 110.

In various embodiments, feature configuration artifact 110 includes one or more names and parameters of features to be extracted, types, window size, output data rate (i.e., “ODR” or “sampling rate”), or number of channels of the sensor or sensors used.

In various embodiments, the features to be extracted include one or more of: absolute energy, maximum, mean, minimum, peak-to-peak distance, variance, skewness, root mean square, median absolute deviation, median, median absolute deviation, kurtosis, average power, zero crossing rate, sum absolute difference, slope, signal distance, positive turning points, neighborhood peaks, negative turning points, median difference, median absolute difference, mean difference, mean absolute difference, centroid, autocorrelation, area under the curve, fundamental frequency, human range energy, max power spectrum, maximum frequency, median frequency, power bandwidth, spectral centroid, spectral decrease, spectral distance, spectral entropy, spectral kurtosis, spectral positive turning points, spectral roll-off, spectral roll-on, spectral skewness, spectral slope, spectral spread, spectral variation, etc., or any combination thereof.

Window size determines a size of window used for feature extraction. In some embodiments, the window size includes a number of samples of the window, such as 500 samples. In some embodiments, the window size includes a provision time for the window, such as two seconds.

In various embodiments, the types of features include statistical features, temporal features, spectral features, etc. In some embodiments, when the type of features to be extracted is specified, features that correspond to the type are extracted. In one nonlimiting example, when the type “spectral,” one or more spectral features such as spectral centroid, spectral decrease, spectral distance, or spectral entropy are to be extracted. In another nonlimiting example, when the type is “statistical,” one or more statistical features such as absolute energy, maximum, mean, minimum, peak-to-peak distance, variance, or skewness are to be extracted.

The output data rate is the rate at which the relevant sensor obtains new measurements. In some embodiments, the ODR corresponds to a number of samples per second taken by the sensor. In one non-limiting example, the ODR is 6.6KHz.

Feature extraction 106 extracts features 112 from data window 102 as specified by feature configuration artifact 110. Features 112 are provided to approximation classifier 114 and reference classifier 120. In some embodiments, a combination of the one or more of features 112 is provided. In one non-limiting example, features 112 are compressed, such as using a hash function, before being provided to approximation classifier 114 or reference classifier 120.

As discussed herein, in various embodiments, approximation classifier 114 is configured to approximate performance of a sensor node classifier implemented at sensor node 101. Based on extracted features 112, approximation classifier 112 produces a first classification 116 for data window 102 (labeled “Tree Output(s)”). First classification 116 is provided to data sufficiency logic 124. In some embodiments, approximation classifier 114 is based on a decision tree, random forest, support vector machine, naïve bayes, logistic regression, other artificial intelligence models, ISPU, k-nearest neighbors, AdaBoost, XGBoost, light gradient boosting machine, CatBoost, Discriminant analysis, or any combination thereof. In some embodiments, an implementation of approximation classifier is based on a type of sensor node 101, a type of classifier implemented using sensor node 101, etc.

Reference classifier 120 is configured to produce second classification 122 (labeled “Clustering Output(s)”) based on features 112. In some embodiments, reference classifier 120 includes K-means classification based on dimensionality reduction algorithm 118. In some embodiments, reference classifier 120 performs clustering using a nearest neighborhood embedding (i.e., “NNE”) algorithm that maps features 112 to a feature space using a distance metric such as cityblock, cosine, Euclidean, L1, L2, Manhattan, etc. In some such embodiments, the nearest class label and distance from cluster centroids is determined using k-means clustering. In various embodiments, clustering is performed using hierarchical NNE (i.e., “h-NNE”), t-distributed stochastic neighbor embedding (i.e., “t-SNE”), or uniform manifold approximation and projection (i.e., “UMAP”). In some embodiments, reference classifier 120 is configured to execute at the gateway device with less than one sample of latency at an ODR of the sensor node. In one non-limiting example, h-NNE requires relatively few processing resources to execute and is selected when the ODR of the sensor node is too high to perform other techniques such as t-SNE or UMAP at the gateway device with a selected latency.

Data sufficiency logic 124 determines whether to provide data window 102 to cloud computing device 108 based on first classification 116 and second classification 120. In various embodiments, data sufficiency logic 124 determines one or more of: (1) whether data window 102 belongs to a certain action primitive that is already accessible to cloud computing device 108 in sufficient quantity; (2) whether data window 102 belongs to a problem-specific data class that is already accessible to cloud computing device 108 in sufficient quantity; (3) whether data window 102 belongs to a problem-specific data class that is irrelevant to a client’s application; (4) whether data window 102 includes outlier or anomalous data samples; (5) whether data window 102 includes data in bulk that is determined to be unlikely to improve performance of the sensor node classifier over a selected period of time; or (6) whether first classification 116 and second classification 122 agree.

In some embodiments, data sufficiency logic 124 assigns data window 102 a class label based on second classification 122 produced by reference classifier 120. In some embodiments, data sufficiency logic 124 assigns an importance score to data window 102. Examples of a process implemented by data sufficiency logic 124 is discussed in detail with respect to FIG. 3.

When data sufficiency logic determines to provide data to cloud computing device 108, gateway device establishes data 128 to provide to cloud computing device 108. In some embodiments, data 128 includes data window 102. In some embodiments, data 128 includes a label for data window 128, such as the second classification 122 produced using reference classifier 120. In some embodiments, data 128 includes the importance score for data window 102.

In some embodiments, gateway device 104 updates approximation classifier 116, dimensionality reduction algorithm 118, reference classifier 120, feature configuration artifact 110, other client-problem specific artifacts 126, or any combination thereof, based on data received from cloud computing device 108 in response to data 128. In one non-limiting example, gateway device 104 receives an updated sensor node classifier to be implemented by sensor node 101 and provides the updated sensor node classifier to sensor node 101.

In various embodiments, gateway device 104 receives data from cloud computing device 108 based on data from one or more other gateway devices. In one non-limiting example, gateway device receives a classifier updated or trained based on data received from multiple gateway devices.

In various embodiments, gateway device 104 receives one or more artifacts from cloud computing device 108 based on a representative training dataset similar or identical

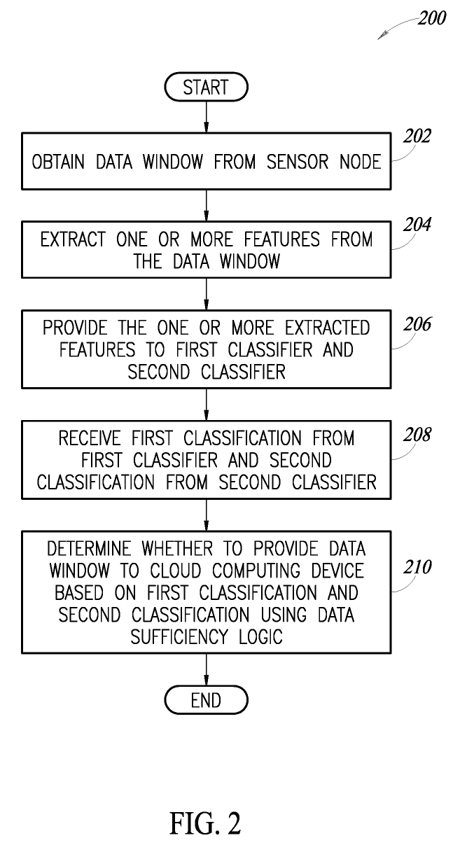

FIG. 2 is a logical flow diagram illustrating a process 200 for determining whether to upload data from a sensor node based on data sufficiency logic in some embodiments. In various embodiments, process 200 is performed using gateway device 104 of FIG. 1.

Process 200 begins, after a start block, at block 202, where a data window is obtained from a sensor node. In some embodiments, the data window is obtained from the sensor node via a wired or wireless connection. After block 202, process 200 proceeds to block 204.

At block 204, one or more features are extracted from the data window. As discussed herein, in various embodiments the one or more features are based on a feature configuration artifact. After block 204, process 200 proceeds to block 206.

At block 206, the one or more extracted features are provided to a first classifier and a second classifier. In some embodiments, the first classifier is an approximation classifier configured to approximate performance of a sensor node classifier implemented by the sensor node. In some embodiments, the second classifier is a reference classifier configured to have higher performance on a relevant classification task than the first classifier. After block 206, process 200 continues to block 208.

At block 208, a first classification is received from the first classifier and a second classification is received from the second classifier. After block 208, process 200 continues to block 210.

At block 210, a determination is made whether to provide the data window to a cloud computing device based on the first classification and the second classification based on data sufficiency logic. Various embodiments of the data sufficiency logic are described in further detail at least with respect to FIGS. 1 and 3. After block 210, process 200 ends at an end block.

In various embodiments, process 200 is periodically performed. In some embodiments, process 200 is performed in response to the gateway device receiving a data window from the sensor node. In some embodiments, process 200 is periodically performed based on an ODR of the sensor node. In various embodiments, process 200 is periodically performed based on a performance metric corresponding to the sensor node classifier or the first classifier. In some embodiments, process 200 is performed with a periodicity based on a running average or other metric computed based on one or more importance scores for one or more data windows, a proportion of data windows provided to a cloud computing device, etc. In one non-limiting example, when the gateway device provides a proportion of data windows above a configurable threshold to the cloud computing device, process 200 is performed with increased periodicity to obtain more relevant data windows for improving performance of the sensor node classifier. In another non-limiting example, when the gateway device provides a proportion of data windows below a configurable threshold to the cloud computing device, process 200 is performed with decreased periodicity.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 3 is a logical flow diagram illustrating a process 300 implementing data sufficiency logic in some embodiments. Process 300 begins, after a start block, at block 302, where a first classification and a second classification of a data window are obtained. After block 302, process 300 continues to block 304.

For each of blocks 304, 306, 308, 310, 312, or 314, in various embodiments, a determination to provide, or not to provide, the data window to a cloud computing device is based on any one of these determinations. Accordingly, in various embodiments, process 300 ends after one of block 304, 306, 308, 310, 312, or 314. Similarly, in various embodiments, process 300 proceeds to block 320 to provide data to the cloud computing device. These connections are omitted from FIG. 3 for visual clarity. As shown in FIG. 3, one or more of these determinations are used to generate an importance score at block 316, and a determination to provide the data window to the cloud computing device is based on the importance score at block 318.

At block 304, a determination is made whether the first classification and the second classification agree. If yes, process 300 proceeds to block 306. If no, process 300 proceeds to block 320. In some embodiments, process 300 proceeds to block 306 when the first classification and the second classification disagree, such as to make other determinations relevant to calculating the importance score for the data window at block 316.

At block 306, a sufficiency of access to data having an action primitive (i.e., a classification) of the data window is determined. In some embodiments, the action primitive of the data window is based on the second classification, which is produced using a reference classifier.

In various embodiments, action primitives correspond to action classifications available to the cloud computing device for a sensor node classifier implemented using the sensor node. In one non-limiting example, when the sensor node is a smart watch, action primitives include actions relevant to a task of tracking actions taken by a user of the smart watch such as “swimming” “bicep curl,” “running,” etc.

In some embodiments, the sufficiency is determined based on a proportion of data having an action primitive of the data window that is accessible to the cloud computing device. Continuing the example above, a proportion of each of the action primitives of “swimming,” “bicep curl,” and “running” accessible by a cloud computing device are obtained, such as 40% “swimming,” 20% “bicep curl,” and 40% “running.” In some embodiments, the proportions of data having the action primitives are obtained from feature configuration artifact 110 of FIG. 1.

In some embodiments, data of the action primitive is determined to be sufficient when the proportion of the action primitive is greater than or equal to a threshold such as (100/n)% of accessible action primitives for the relevant task, where n is the total number of action primitives, or classifications, for the task. Continuing the example, the threshold of sufficiency is approximately 33%. When the data window action primitive is “swimming” sufficient data is accessible because the proportion of data with “swimming” action primitive is 40%, which is greater than the sufficiency threshold of approximately 33%. When the data window action primitive is “bicep curl,” insufficient data is accessible because the proportion of data with “bicep curl” action primitive is 20%, which is less than the sufficiency threshold of approximately 33%. After block 306, process 300 continues to block 308.

At block 308, a relevance of the data window for a task is determined. In one non-limiting example, when the task is tracking user actions, action primitives such as “swimming,” “running,” or “bicep curl,” are relevant, while other action primitives such as “stationary” are irrelevant. Accordingly, in some embodiments, the relevance of the data window is a first value, such as “1” when the action primitive of the data window is included in a set of action primitives that correspond to the task, and the relevance of the data window is a second value, such as “0” when the action primitive of the data window is not included in the set of action primitives that correspond to the task. After block 308, process 300 continues to block 310.

At block 310, a sufficiency of access to data having a problem-specific data class of the data window is determined. A problem-specific data class refers to a data class that corresponds with a relevant task. In one non-limiting example, when the task is asset tracking, the problem specific data classes that correspond to the task include “motion,” “shake,” “static,” and “static not upright.” In various embodiments, block 310 employs techniques similar to those discussed with respect to block 306. After block 310, process 300 continues to block 312.

At block 312, a determination whether the data window includes an outlier or anomalous data sample is made. In some embodiments where the second classifier includes a clustering algorithm, the determination is made based on a distance of the data window from a cluster centroid.

In some embodiments, when the first classification and the second classification disagree and the clustering performed by the second classifier indicates an anomalous distance ( e.g., the distance of the dimensionality-reduced data window is greater than a maximum distance of points for all classes from the cluster centroids), then it is determined to provide the data window to the cloud computing device. This case may indicate a new data point that falls outside the feature distribution of the training dataset.

In some embodiments, when the first classification and second classification disagree and the clustering algorithm of the second classifier indicates a non-anomalous distance (e.g., the distance of the dimensionality-reduced data window is less than a maximum distance of points for all class from the cluster centroids), then it is determined to provide the data window to the cloud computing device. This case may indicate a new data point that falls within the feature distribution of the training dataset, but is likely at a boundary between two classes.

In some embodiments, when the first classification and the second classification agree and the clustering algorithm of the second classifier indicates a non-anomalous distance (e.g. the distance of the dimensionality-reduced data window is less than a maximum distance of points for all classes from the cluster centroids), then a determination whether to provide the data window to the cloud computing device is made based on other determinations made at one or more of blocks 306, 308, or 310.

In some embodiments, when the first classification and the second classification agree and the clustering algorithm of the second classifier indicates an anomalous distance (e.g., a distance of the dimensionality-reduced data window is greater than a maximum distance of points for all classes from the cluster centroids), then the data window is determined to be provided to the based on a configurable setting. This case may indicate either: (1) that the data window falls outside a feature distribution of the training dataset, but the location of the data window is in the same region in the latent space of both the first classifier and the second classifier, in which case the data window is to be streamed; or (2) the data window is anomalous, and is not to be streamed. After block 312, process 300 continues to block 314.

At block 314, a performance relevance of the data window is determined. In some embodiments, the data window is determined to be irrelevant for improving performance when similar data is already accessible to cloud computing device 108. In one non-limiting example, when the data window corresponds to a default state of the sensor node, such as a stationary smart watch, and similar data is accessible to cloud computing device 208, it is determined that the data window is irrelevant. After block 314, process 300 continues to block 316.

At block 316, an importance score is calculated for the data window. In various embodiments, the importance score is determined based on one or more determinations made in blocks 304, 306, 308, 310, 312, or 314. In some embodiments, the importance score is assigned a first value such as -1 when the first and second classifications agree at block 304. In some embodiments, the importance score is assigned a second value such as 0 when any of the determinations at blocks 306, 308, 310, 312, or 314, are false. In some embodiments, the importance score is assigned a third value such as 1 when any of conditions (1), (2), (3), (4), or (5) indicate that the data window should not be provided to the computing device. In various embodiments, data sufficiency logic 124 determines whether to provide data window 102 to cloud computing device 108 based on the score assigned. In one non-limiting example, data window 102 is provided when the importance score is the first value or the second value, and data window 102 is not provided when the importance score is the third value. In some embodiments, the importance score is a number, such as a number between 0 and 6, that corresponds to a number of determinations that are true. In some embodiments, the importance score is a weighted combination of one or more of the determinations. In some such embodiments, each determination is assigned a weight based on a relevance of the determination. In one non-limiting example, whether first classification 116 and second classification 122 agree is assigned a higher weight relative to other determinations.

In one non-limiting example, each determination that indicates that the data is to be provided to the cloud computing device increases the importance score by a configurable amount, such as 1.

In some embodiments, data sufficiency logic 124 determines whether to provide data 128 to cloud computing device 108 based on other client-problem specific artifacts 126. In various embodiments, other client-problem specific artifacts 126 includes class labels, a number of data windows belonging to each class, other information regarding a dataset or relevant task, etc. After block 316, process 300 continues to decision block 318.

At decision block 318, a determination whether the importance score satisfies a threshold. If yes, process 300 continues to block 320. In various embodiments, the threshold has any value. If no, process 300 ends at an end block.

At block 320, data is provided to the cloud computing device. In various embodiments, the data includes the data window, the importance score, the first classification, the second classification, or any combination thereof. After block 320, process 300 ends at an end block.

FIG. 4 is a block diagram illustrating a process 400 for generating artifacts used to determine whether to upload data from a sensor node based on data sufficiency logic in some embodiments. In various embodiments, process 400 is implemented using cloud computing device 108 of FIG. 1.

Process 400 begins, after a start block, at block 402, where representative training data for a relevant classification task is received. In some embodiments, the representative training data was used to train a sensor node classifier implemented using sensor node 101 of FIG. 1. In one non-limiting example where the sensor node is smartwatch and the relevant task is classifying an activity of a user of the smartwatch, the representative training dataset includes sensor data and a corresponding activity classification for the sensor data. In various embodiments, the representative training data includes examples of time series data and corresponding classification labels. Block 402 yields representative training data 404. After block 402, process 400 continues to block 406.

At block 406, metadata about the representative training data is received, yielding metadata 408. In some embodiments, the metadata is received from a user associated with sensor node 101, such as a manufacturer of sensor node 101, a distributor of sensor node 101, an entity that provides

In various embodiments, metadata 408 includes configuration details for processing the representative training data such as a name, class labels, one or more window sizes used to window the data, one or more strides determining an offset between data windows, or sensor configuration details such as an ODR of each relevant sensor, full scales of each sensor, or any other sensor parameters.

In some embodiments, metadata 408 is included in feature configuration artifact 110 of FIG. 1. After block 406, process 400 proceeds to block 410.

At block 410, the representative training data is formatted. In some embodiments, the representative training data is formatted into one or more matrices. After block 410, process 400 continues to block 412.

At block 412, the representative training data is windowed. In some embodiments, the representative training data is windowed based on metadata 408. In one non-limiting example, the representative training data is windowed according to a window sizes and a stride of metadata 408. In various embodiments, block 412 yields artifact a 413a, artifact b 413b, and artifact c 413c. In some embodiments, artifact a 413a includes one or more of a window size, stride, ODR, number of channels in the windowed data, or other parameters used to window the data. In some embodiments, artifact b 413b includes class label names. In some embodiments, artifact c 413c includes a number of data windows belonging to each class. After block 412, process 400 continues to block 414.

At block 414, features of the windowed data are extracted. In various embodiments, block 414 employs techniques similar to those discussed with respect to feature extraction 106 of FIG. 1. After block 414, process 400 continues to block 416.

At block 416, the dataset is split into a training set and a testing set. In various embodiments, any split is used. In one non-limiting example, the training set includes 80% of the dataset and the testing set includes 20% of the dataset. After block 416, process 400 proceeds to block 418.

At block 418, a supervised classifier is trained using the training dataset. In various embodiments, an architecture of the supervised classifier is based on metadata 408. After block 418, process 400 continues to block 420.

At block 420, feature selection is performed. In various embodiments, feature selection is performed to identify extracted features that are predictive for the relevant task. In various embodiments, feature selection is performed based on one or more of recursive feature elimination, random forest, AdaBoost, variance analysis, etc., or any combination thereof. In some embodiments, a specified number of features are selected, such as 5 features, 10 features, 20 features, etc. In some embodiments, features are selected based on a predictiveness threshold. After block 420, process 400 continues to block 422.

At block 422, the supervised classifier is retrained based on the selected features. In some embodiments, the supervised classifier is trained from arbitrarily initialized parameters. In some embodiments, the supervised classifier is trained based on parameters established through training at block 418. Block 422 yields artifact d 413d and artifact e 413e. In some embodiments, artifact d 413d includes a feature list of selected features and parameters used. In some embodiments, artifact e 413e includes a representation of the retrained supervised classifier, such as an Onnx object based on the retrained supervised classifier. In various embodiments, gateway device 104 uses artifact e 413e as approximation classifier 114 of FIG. 1. After block 422, process 400 continues to block 424.

At block 424, a reference classifier is trained based on the selected features. In some embodiments, the reference classifier is based on an h-NNE algorithm or other dimensionality reduction algorithm such as t-SNE or UMAP. After block 424, process 400 continues to block 426.

At block 426, the output of the dimensionality reduction algorithm is fit using a clustering algorithm such as K-Means clustering. In various embodiments, block 426 yields artifact f 413f and artifact g 413g. In some embodiments, artifact f 413f includes the trained dimensionality reduction algorithm. In some embodiments, artifact f 413f is a pickle object. In some embodiments, gateway device 104 uses artifact f 413f as dimensionality reduction algorithm 118.

In some embodiments, artifact g 413g includes cluster centroids and cluster labels. In some embodiments, artifact g 413g is a JavaScript Object Notation (i.e., “JSON”) object. In some embodiments, gateway device 104 uses artifact g 413g as reference classifier 120. After block 426, process 400 ends at an end block.

In various embodiments, one or more blocks of process 400 are performed in response to receiving data from gateway device 104. In one non-limiting example, in response to receiving data including a data window and corresponding label, blocks 422, 424, and 426 are performed to produce one or more updated artifacts such as artifact d 413d, artifact e 413e, artifact f 413f, or artifact g 413g. In some embodiments, the one or more updated artifacts are provided to gateway device 104 to be used as described herein. In some embodiments, artifact e 413e is provided to sensor node 101 of FIG. 1 to be implemented as a sensor node classifier.

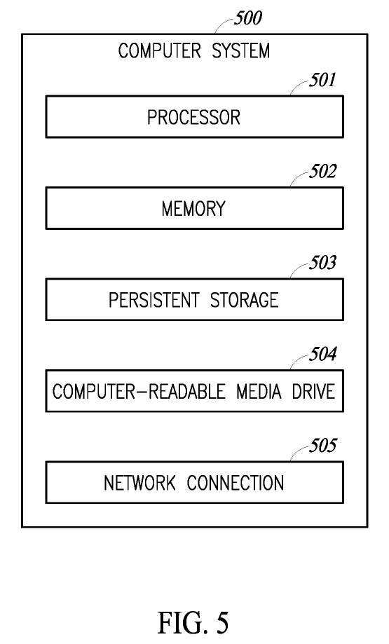

FIG. 5 is a block diagram showing some of the components typically incorporated in at least some of the computer systems and other devices on which the facility operates, such as gateway device 104 of FIG. 1. In various embodiments, these computer systems and other devices 500 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 501 for executing computer programs and/or training or applying machine learning models, such as a CPU, GPU, TPU, NNP, FPGA, or ASIC; a computer memory 502—such as RAM, SDRAM, ROM, PROM, etc.—for storing programs and data while they are being used, including the facility and associated data, an operating system including a kernel, and device drivers; a persistent storage device 503, such as a hard drive or flash drive for persistently storing programs and data; a computer-readable media drive 504, such as a floppy, CD-ROM, or DVD drive, for reading programs and data stored on a computer-readable medium; and a network connection 505 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

The following is a summarization of the claims as originally filed.

In various embodiments, a method includes: obtaining, by a gateway device in communication with a sensor node, a data window via the sensor node; extracting, by the gateway device, a plurality of features of the data window; providing the plurality of features to an approximation classifier that is configured to approximate performance of a sensor node classifier implemented using the sensor node; obtaining via the approximation classifier and based on the plurality of features, an approximate classification that is representative of a classification of the data window potentially made by the sensor node classifier; providing the plurality of features to a reference classifier; obtaining via the reference classifier and based on the plurality of features, a reference classification; and determining, by the gateway device, based on the approximate classification and the reference classification, whether to provide the data window to a computing device separate from the gateway device.

In some embodiments, the method further includes: determining that the approximate classification and the reference classification do not agree; and based on determining that the approximate classification and the reference classification do not agree, providing the data window to the computing device.

In some embodiments, the method further includes: determining that the approximate classification and the reference classification agree; and determining not to provide the data window to the computing device.

In some embodiments, the method further includes: determining that the approximate classification and the reference classification agree; identifying an action primitive of the data window; determining a proportion of each action primitive accessible to the computing device; determining that data windows having the action primitive do not exist in sufficient quantity at the computing device based on the proportion of each action primitive accessible to the computing device; and providing the data window to the computing device.

In some embodiments, the method further includes: determining that the approximate classification and the reference classification agree; identifying a problem-specific data class of the data window; determining that data windows having the problem-specific data class do not exist in sufficient quantity at the computing device; and providing the data window to the computing device.

In some embodiments, the method further includes: determining that the approximate classification and the reference classification agree; identifying a problem-specific data class of the data window; determining that the problem-specific data class is relevant to a task; and providing the data window to the computing device.

In some embodiments, the method further includes: determining that the approximate classification and the reference classification agree; determining that the data window is anomalous; and determining not to provide the data window to the computing device based on determining that the data window is anomalous.

In some embodiments, the method further includes: determining that the approximation classification and the reference classification agree; determining that the data window is redundant to data at the computing device; and determining not to upload the data sample based on determining that the data window is redundant to data at the computing device.

In some embodiments, determining whether to provide the data window to the computing device includes: determining an importance score for the data window; and determining whether to provide the data window to the computing device based on comparing the importance score to an importance score threshold.

In some embodiments, the method further includes: receiving a feature configuration artifact from the computing device; and extracting the plurality of features of the data window based on the feature configuration artifact.

In some embodiments, the method further includes: receiving the approximation classifier and the reference classifier from the computing device.

In some embodiments, the method further includes: providing the data window and the reference classification to the computing device; receiving an updated sensor node classifier from the computing device, wherein the updated sensor node classifier was updated based on the reference classification and the data window; and providing the updated sensor node classifier to the sensor node.

In some embodiments, the approximation classifier has a same architecture as a sensor node classifier implemented using the sensor node, and the reference classifier is based on a clustering algorithm.

In some embodiments, the method further includes: determining an importance score for the data window; and providing the data window and the importance score to the computing device.

In some embodiments, the approximation classifier includes a decision tree.

In various embodiments a system includes: one or more processors; and one or more memories storing contents executable by the one or more processors to: obtain a data window via a sensor node; extract a plurality of features of the data window; provide the plurality of features to a first classifier and a second classifier; receive a first classification and a second classification of the data window via the first classifier and the second classifier, respectively; determine that the first classification and the second classification do not agree; and in response to determining that the first classification and the second classification do not agree, provide the data window to a computing device to be used to train a classifier to be implemented at the sensor node.

In some embodiments of the system, the one or more processors are further configured to: receive a feature configuration artifact from the computing device; and extract the plurality of features of the data window based on the feature configuration artifact.

In various embodiments, one or more non-transitory computer-readable media store contents executable by one or more processors to perform actions, the actions including: obtaining a data window; extracting a plurality of features of the data window; providing the plurality of features to a first classifier and a second classifier; receiving a first classification and a second classification of the data window via the first classifier and the second classifier, respectively; determining that the first classification and second classification disagree; and providing the data window to a computing device based on determining that the first classification and the second classification disagree.

In some embodiments of the one or more non-transitory computer-readable media, the actions further include: causing the computing device to train a sensor node classifier using the data window; receiving the trained sensor node classifier; and deploying the trained sensor node classifier to the sensor node.

In some embodiments of the one or more non-transitory computer-readable media, the first classifier is configured to approximate performance of a sensor node classifier deployed at the sensor node.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
obtaining, by a gateway device in communication with a sensor node, a data window via the sensor node;
extracting, by the gateway device, a plurality of features of the data window;
providing the plurality of features to an approximation classifier that is configured to approximate performance of a sensor node classifier implemented using the sensor node;
obtaining via the approximation classifier and based on the plurality of features, an approximate classification that is representative of a classification of the data window potentially made by the sensor node classifier;
providing the plurality of features to a reference classifier;
obtaining via the reference classifier and based on the plurality of features, a reference classification; and
determining, by the gateway device, based on the approximate classification and the reference classification, whether to provide the data window to a computing device separate from the gateway device.

2. The method of claim 1, further comprising:
determining that the approximate classification and the reference classification do not agree; and
based on determining that the approximate classification and the reference classification do not agree, providing the data window to the computing device.

3. The method of claim 1, further comprising:
determining that the approximate classification and the reference classification agree; and
determining not to provide the data window to the computing device.

4. The method of claim 1, further comprising:
determining that the approximate classification and the reference classification agree;
identifying an action pr7imitive of the data window;
determining a proportion of each action primitive accessible to the computing device;
determining that data windows having the action primitive do not exist in sufficient quantity at the computing device based on the proportion of each action primitive accessible to the computing device; and
providing the data window to the computing device.

5. The method of claim 1, further comprising:
determining that the approximate classification and the reference classification agree;
identifying a problem-specific data class of the data window;
determining that data windows having the problem-specific data class do not exist in sufficient quantity at the computing device; and
providing the data window to the computing device.

6. The method of claim 1, further comprising:
determining that the approximate classification and the reference classification agree;
identifying a problem-specific data class of the data window;
determining that the problem-specific data class is relevant to a task; and
providing the data window to the computing device.

7. The method of claim 1, further comprising:
determining that the approximate classification and the reference classification agree;
determining that the data window is anomalous; and
determining not to provide the data window to the computing device based on determining that the data window is anomalous.

8. The method of claim 1, further comprising:
determining that the approximation classification and the reference classification agree;
determining that the data window is redundant to data at the computing device; and
determining not to upload the data sample based on determining that the data window is redundant to data at the computing device.

9. The method of claim 1, wherein determining whether to provide the data window to the computing device includes:
determining an importance score for the data window; and
determining whether to provide the data window to the computing device based on comparing the importance score to an importance score threshold.

10. The method of claim 1, further comprising:
receiving a feature configuration artifact from the computing device; and
extracting the plurality of features of the data window based on the feature configuration artifact.

11. The method of claim 1, further comprising:
receiving the approximation classifier and the reference classifier from the computing device.

12. The method of claim 1, further comprising:
providing the data window and the reference classification to the computing device;
receiving an updated sensor node classifier from the computing device, wherein the updated sensor node classifier was updated based on the reference classification and the data window; and
providing the updated sensor node classifier to the sensor node.

13. The method of claim 1, wherein the approximation classifier has a same architecture as a sensor node classifier implemented using the sensor node, and the reference classifier is based on a clustering algorithm.

14. The method of claim 1, further comprising:
determining an importance score for the data window; and
providing the data window and the importance score to the computing device.

15. The method of claim 1, wherein the approximation classifier includes a decision tree.

16. A system comprising:
one or more processors; and
one or more memories storing contents executable by the one or more processors to:
obtain a data window via a sensor node;
extract a plurality of features of the data window;
provide the plurality of features to a first classifier and a second classifier;
receive a first classification and a second classification of the data window via the first classifier and the second classifier, respectively;
determine that the first classification and the second classification do not agree; and
in response to determining that the first classification and the second classification do not agree, provide the data window to a computing device to be used to train a classifier to be implemented at the sensor node.

17. The system of claim 16, wherein the one or more processors are further configured to:
receive a feature configuration artifact from the computing device; and
extract the plurality of features of the data window based on the feature configuration artifact.

18. One or more non-transitory computer-readable media storing contents executable by one or more processors to perform actions, the actions comprising:
obtaining a data window;
extracting a plurality of features of the data window;
providing the plurality of features to a first classifier and a second classifier;
receiving a first classification and a second classification of the data window via the first classifier and the second classifier, respectively;
determining that the first classification and second classification disagree; and
providing the data window to a computing device based on determining that the first classification and the second classification disagree.

19. The one or more non-transitory computer-readable media of claim 18, the actions further comprising:
causing the computing device to train a sensor node classifier using the data window;
receiving the trained sensor node classifier; and
deploying the trained sensor node classifier to the sensor node.

20. The one or more non-transitory computer-readable media of claim 18, wherein the first classifier is configured to approximate performance of a sensor node classifier deployed at the sensor node.
